(19) United States
(12) Patent Application Publication
(10) Pub. No.: US 2024/0059585 A1
(43) Pub. Date: Feb. 22, 2024

(54) ENERGY INTEGRATED WATER PURIFICATION AND RECOVERY SYSTEM AND METHOD FOR USING SAME

(71) Applicant: AIZACO LIMITED COMPANY, Frisco, TX (US)

(72) Inventor: Carlos Alberto Hernandez Gutierrez, Frisco, TX (US)

(21) Appl. No.: 18/234,715

(22) Filed: Aug. 16, 2023

Related U.S. Application Data
(60) Provisional application No. 63/398,966, filed on Aug. 18, 2022.

(51) Int. Cl. C02F 1/04; C02F 11/13; B01D 1/00; B01D 3/14; B01D 1/30

(52) U.S. Cl. CPC C02F 1/048; C02F 11/13; B01D 1/0023; B01D 3/148; B01D 1/30; C02F 2201/009; C02F 2303/10; C02F 2301/08

(57) ABSTRACT

A water purification and recovery system and method are provided for treating unprocessed water to produce purified water suitable for any of several uses. The system and method include energy reduction and integration features which enhance cooperation between a sludge recovery module and water purification module. The modules of the system perform sequential separation of solid and dissolved contaminants and impurities, respectively, from the unprocessed water. The sludge recovery module includes two or more induction heaters which are operated at least in part by electricity produced using steam formed in the sludge recovery module by the induction heaters. Purified water and, optionally, one or more concentrated non-aqueous products are produced from the water purification module.

### CROSS-REFERENCE TO RELATED APPLICATIONS

The present patent application claims the benefit, under 35 U.S.C. § 119(e), of U.S. Provisional Patent Application No. 63/398,966, filed Aug. 18, 2022, the entire disclosure of which is incorporated by reference herein.

### FIELD OF THE INVENTION

The invention described and contemplated herein relates to a system and method for recovering purified water from unprocessed water. In particular, the system and method include energy reduction and integration features and perform sequential separation of solid and dissolved contaminants and impurities from unprocessed water, whereby sludge and one or more concentrated product streams are produced, in addition to purified water.

### BACKGROUND

Due to ongoing industrialization around the world and ever-increasing human populations, systems and methods for the efficient and cost-effective remediation, treatment, and recovery of water suitable for agriculture and drinking from water sources which are contaminated or otherwise unsuitable for such uses continue to be important and under study and development.

A significant amount of energy input is required for purifying unprocessed water, e.g., from contaminated or otherwise unsuitable water sources, by applying heat to form steam or perform distillation, or fractionation, to separate water from unwanted contaminants and other substances. This is particularly true when the water source contains large concentrations, or a great number of different kinds, of unwanted contaminants and other substances. This is also true when a large quantity or volume of water is to be purified.

There have been many systems, devices, methods, and techniques studied and developed for purification and recovery of water from water sources which are contaminated or otherwise unsuitable for the desired uses. Some such systems and methods have included recycling process streams, repurposing material stream previously discarded, as well as integrating energy production and energy consumption to reduce overall energy requirements. Nonetheless, more energy and time efficient, devices, methods, and techniques continue to be sought and welcomed.

### SUMMARY OF THE INVENTION

An energy integrated water purification system is described hereinbelow for recovering purified water from unprocessed water which contains one or more impurities including solid impurities, dissolved impurities, and vapor impurities. The system comprises: a sludge recovery module which includes a heated conduit having a length extending between an upstream inlet end and a downstream outlet end, a plurality of induction heaters disposed along the length of the heated conduit and mounted in thermal communication therewith and being capable of heating the heated conduit and unprocessed water flowing therethrough, thereby producing sludge product comprising one or more of the solid impurities and hot mixed vapor product comprising water and one or more of the dissolved impurities and the vapor impurities, one or more electric power sources capable of recovering and converting energy from the hot mixed vapor stream to electricity, and using the electricity to activate the plurality of induction heaters to heat additional unprocessed water, thereby producing additional hot mixed vapor product, and additional sludge product, and a main vapor conduit, which is in direct or indirect fluid communication with the one or more electric power sources and is capable of receiving and combining mixed vapor product, after energy from the hot vapor stream has been converted to electricity, from the one or more electrical power sources to form a combined mixed vapor product; and a water purification module which is capable of receiving the combined mixed vapor product from the main vapor conduit of the sludge recovery module, separating at least a portion of the dissolved impurities and vapor impurities from the combined mixed vapor product, and producing purified water.

In some exemplary embodiments, each of the one or more electric power sources of the sludge recovery module comprises: one or more steam turbines, each of which is capable of receiving hot mixed vapor product from the heated conduit and converting energy therefrom to work energy; and one or more electric generators, each of which is associated with a respective one of the one or more steam turbines and is capable of receiving and converting work energy from the respective one of the one or more steam turbines to electricity, and wherein each of the one or more electric generators is connected to and capable of activating at least one of the plurality of inductive heaters.

In some exemplary embodiments, the water purification module includes a distillation column which is capable of fractionally separating dissolved impurities and vapor impurities from the combined mixed vapor product. The distillation column may be further capable of producing one or more non-aqueous products, each of which comprises a selected dissolved impurity, a selected vapor impurity, of a combination thereof.

In some exemplary embodiments, the sludge recovery module also includes a sludge conveying device disposed proximate the downstream outlet end of the heated conduit and capable of conveying the sludge product out of the downstream outlet end of the heated conduit.

A method is also described below for recovering purified water from unprocessed water containing one or more impurities including solid impurities, dissolved impurities, and vapor impurities. The method includes the steps of: separating solid impurities from the unprocessed water by heating the unprocessed water using a plurality of inductive heaters and producing sludge product containing solid impurities, and hot mixed vapor product containing water and one or more of dissolved impurities, vapor impurities, or a combination thereof, converting energy from the hot mixed vapor product to electricity, at least partially operating the plurality of inductive heaters using the electricity to heat additional unprocessed water and thereby produce additional sludge product and additional hot mixed water vapor product, and collecting and combining mixed vapor product, which remains after converting energy from the hot mixed vapor product, to form a combined mixed vapor product; and separating one or more of dissolved impurities, vapor impurities, or combinations thereof, from the combined mixed vapor product and producing purified water.

In some embodiments, the step of converting energy from the hot mixed vapor product to electricity is performed at least in part by: providing hot mixed vapor product to one or more turbines, each of which produces work energy and the mixed vapor product which remains after converting energy from the hot mixed vapor product, and transferring the work energy to one or more electric generators, each of which converts work energy to electricity, which is used to operate, at least in part, the plurality of inductive heaters.

In some embodiments, the step of separating one or more of dissolved impurities, vapor impurities, or combinations thereof, from the combined mixed vapor product comprises fractional separation and one or more non-aqueous products are also produced, each of the one or more non-aqueous products comprising a selected dissolved impurity, a selected vapor impurity, or a combination thereof.

### BRIEF DESCRIPTION OF THE FIGURES

The present invention will be further explained with reference to the attached drawings, wherein like structures are referred to by like numerals and/or letters throughout the several views. The figures may be schematic and, therefore, drawings shown are not necessarily to scale, with emphasis instead generally upon illustrating the principles of the present invention. For the purposes of illustrating the invention disclosed and contemplated herein, exemplary embodiments are shown in the drawings, in which the details of known and conventional features or apparatus may not be specifically shown but are nonetheless reasonably understood and expected to be present. Descriptions provided for elements and features which are shown and identified using a numeral in the figures are applicable, unless otherwise indicated, to those and analogous elements and features shown and identified by those same numerals in any subsequent figure.

FIG. 1 is a perspective schematic view of an exemplary embodiment of an integrated water purification and recovery system, as well as an equalization tank from which untreated water is fed to the system and a storage vessel for receiving purified water from the system;

FIG. 2 is a top schematic view of the water purification and recovery system, equalization tank and storage vessel of FIG. 1;

FIG. 3 is an enlarged top schematic view of the water purification and recovery system of FIGS. 1 and 2, which includes a sludge recovery module and a water purification module;

FIG. 4 is an enlarged schematic perspective view of an upstream portion of the sludge recovery module;

FIG. 5 is an enlarged schematic perspective view of a downstream portion of the sludge recovery module; and

FIG. 6 is an enlarged schematic perspective view of the water purification module.

### DETAILED DESCRIPTION

The water purification and recovery system and method described and contemplated herein treat unprocessed water to produce purified water suitable for any of several uses for which the unprocessed water was unsafe or otherwise unsuitable. As described in detail below, the system and method include energy reduction and integration features which enhance cooperation between a sludge recovery module and water purification module, which perform sequential separation of solid and dissolved contaminants and impurities, respectively.

Unprocessed water which may be treated by the system and method described and contemplated herein may be water from any source that contains unsafe or unwanted concentrations of contaminants or impurities. This includes, without limitation, industrial, residential, or other wastewater; wastewater from mining, oil, or gas operations and production; surface water such as a pond, lake, wetland, stream, river, estuary, ocean, etc.; and ground water such as aquifer water.

“Unprocessed water” means water which has not yet been subjected to processing using the system and method described and contemplated herein and still contains unwanted impurities susceptible to separation and removal. The term “unprocessed water” is not intended to mean that the water has not undergone any treatment or processing before being subjected to the presently described and contemplated system and method. Rather, many water treatment and processing techniques exist and any one or more of them may be applied to water containing contaminants and impurities prior to the unprocessed water being provided to the presently described and contemplated separation and purification system and method. For example, without limitation, some solid impurities may be removed, such as by settling in a sedimentation pond or filtering, before the unprocessed water is provided to the present system and method. Also, for example without limitation, certain impurities may be degraded, broken down, bound or precipitated, such as by addition of bioremediation microorganisms, chelating agents, or other reagents, to the water, before the unprocessed water is provided to the present system and method.

Hereinafter, the terms “impurity” and “impurities” will be used to mean any one or more contaminants, impurities, substances, or materials, which are unwanted, unsafe, or both, based on the nature of the impurity itself and its quantity or concentration in the unprocessed water. The state of impurities present in unprocessed water is not particularly limited and include one or more of solids, dissolved, liquids, vapors, or intermediate phases. There exists an infinite number of impurities which could be present in unprocessed water and whose removal is necessary to produce purified water of the quality suitable for drinking and other household uses, as well as agriculture, and industrial processing.

While by no means an exhaustive list, examples of impurities which may be present in unprocessed water and which the system and method described and contemplated herein are capable of separating and removing from the water include, without limitation: volatile organic compounds, semivolatile organic compounds, suspended solids, dissolved solids, particulate plastics (e.g., microplastics and nanoplastics), microorganisms, and decaying plant and other organic matter. Non-limiting examples of volatile organic compounds (VOCs) include: acetone, ethanol, toluene, isopropanol (i.e., alcohol), carbon disulfide, chloroform, benzene, trichloroethylene (TCE), dichloromethane (i.e., methylene chloride), di chloroethane (i.e., ethylene dichloride (EDC)), and chloroethylene (i.e., vinyl chloride). Non-limiting examples of semivolatile organic compounds (SVOCs) include: benzoic acid, benzyl alcohol, benzyl phthalate, nitrobenzene, dichlorobenzene, trichlorobenzene, dinitrotoluene. naphthalene, chlorophenyl phenyl, pesticides, flame retardants (e.g., polychlorinated biphenyls), aldehydes, phenols, ketones, amines, amides, nitroaromatics, nitrosamines, and trihalomethanes.

Suspended solids are typically, but not necessarily, about 2 microns or greater in size, do not dissolve in water, and mostly comprise inorganic materials, but may also include microorganisms. Non-limiting examples of suspended solids include: sand, sediment, clay, particles from decaying plants or animals, algae, bacteria, and plankton. Dissolved solids, on the other hand, are typically, but not necessarily, less than about 2 microns in size, and comprise a combination of inorganic and organic substances which are dissolved in water. Types of dissolved solids found in water include minerals, salts, dissolved metals, and other organic matter. Non-limiting examples of mineral dissolved solids include: magnesium, calcium, potassium. Non-limiting examples of salts (i.e., anions and cations) found in water as dissolved solids include: sodium, chlorides, carbonates, nitrates, and sulphates. Non-limiting examples of dissolved metal solids include: lead, copper, and iron,

Microplastics are generally pieces and fragments of plastic material of about 5 millimeters (mm) or less in size, and may even be as small as about 0.1 micron. Nanoplastics are generally pieces and fragments of plastic material of less than about 0.1 micron. Microplastics and nanoplastics exist in different sizes and shapes such as, without limitation pellets, flakes and powders. Microplastics include those released directly into the environment (i.e., “primary” microplastics), as well as those formed indirectly in the environment (i.e., “secondary” microplastics) such as through decay or degradation (which tends to occur slowly), whether by physical, mechanical, chemical, or radiation exposure mechanisms.

The invention described and contemplated herein provides a system and method for recovering purified water from unprocessed water using energy integrated features and processes. Solid impurities, and then dissolved and vapor impurities, are sequentially separated from unprocessed water to produce purified water, as well as sludge and one or more concentrated non-aqueous product streams. As used herein, “non-aqueous” does not necessarily mean the complete absence of water, but rather, a non-aqueous product stream, whether dissolved or vapor, comprises no more than about 10%, by weight, water.

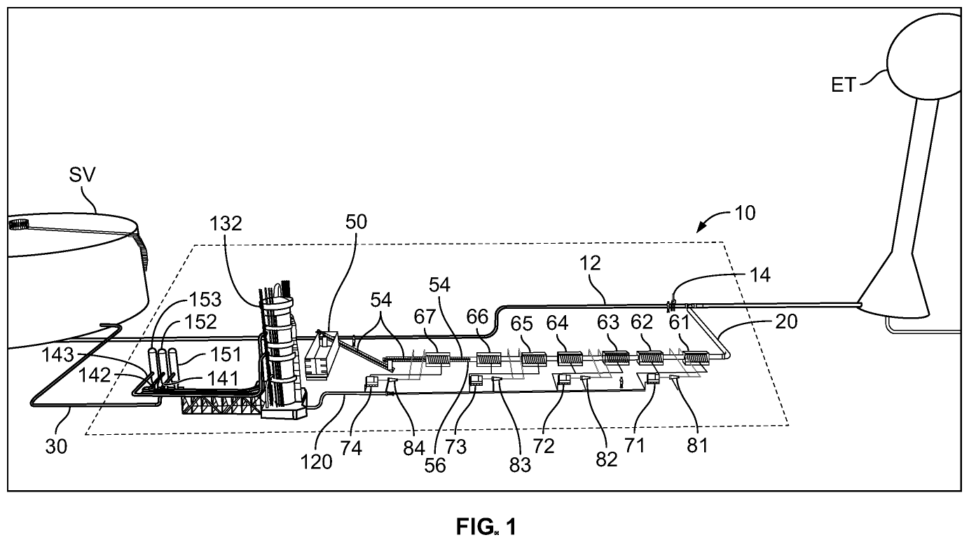

With reference now to the figures, and to FIGS. 1-3 in particular, an exemplary embodiment of an integrated water purification and separation system 10 is shown. Unpurified water (not shown per se) which contains water and impurities is provided to the system 10 through a conduit, such as the inlet pipe 20 shown, which is in fluid communication, directly or indirectly, with the source of the unprocessed water. At least a portion of the impurities comprises solid impurities, whether suspended, dissolved, or a combination thereof. At least another portion of the impurities comprises dissolved and vapor impurities. Each of the solid, dissolved, liquid, and vapor impurities, independently of the others, may or may not be distributed homogenously throughout the unprocessed water.

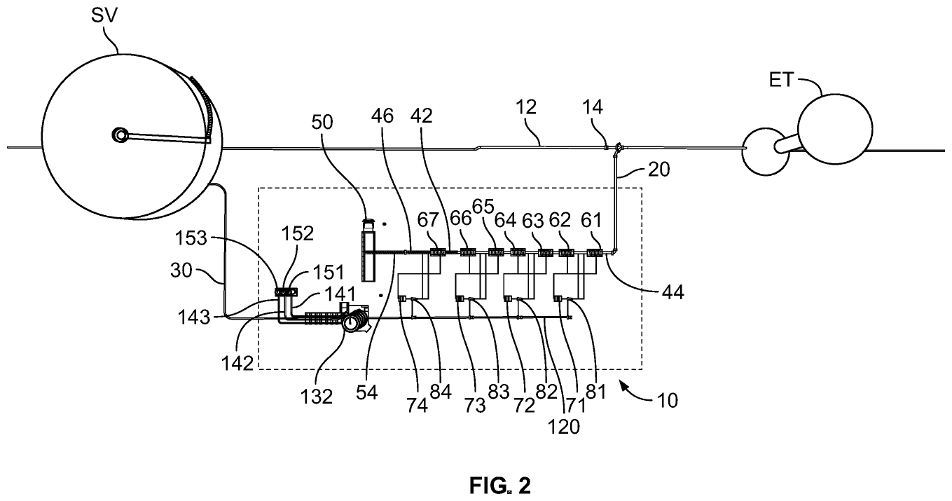

The flow rate of the unprocessed water from its source may vary widely, unexpectedly, and intermittently. As shown in FIGS. 1 and 2, to provide a more steady flow rate of unprocessed water into the system 10, unprocessed water may first be provided to and held in an equalization tank ET, or other flow dampening apparatus, and then to the system 10, via inlet pipe 20 in a controlled manner with less fluctuation.

Another technique for controlling the flow rate of unprocessed water from its source to the system 10 is shown in FIGS. 1-3. More particularly, a bypass conduit or pipe 12 is connected in fluid communication with the inlet pipe 20, upstream of the system 10 and a flow control device, such as a butterfly valve 14, is provided on the bypass pipe 12. When the flow rate of unprocessed water is too high, the butterfly valve 14 can be opened to divert at least a portion of the unprocessed water from the inlet pipe 20 to the bypass pipe 12. Otherwise, the butterfly valve 14 can be at least partially or completely closed, which allows more of the unprocessed water to continue through the inlet pipe 20 and into the system 10. The butterfly valve 14 also provides a safety shut-off point for stopping the flow of unprocessed water to the system 10 in the event of malfunction, maintenance, or other event which requires stopping the operation of the system 10.

As also shown in FIGS. 1 and 2, purified water (not shown per se) ultimately produced by the system 10 may be conveyed from the system 10, through a conduit, such as the outlet pipe 30, to a storage vessel SV where it is collected and held. A condenser (not shown) may, optionally, be provided in thermal communication with at least a portion of the outlet pipe 30 for condensing purified water vapor to purified liquid water before it reaches the storage vessel SV.

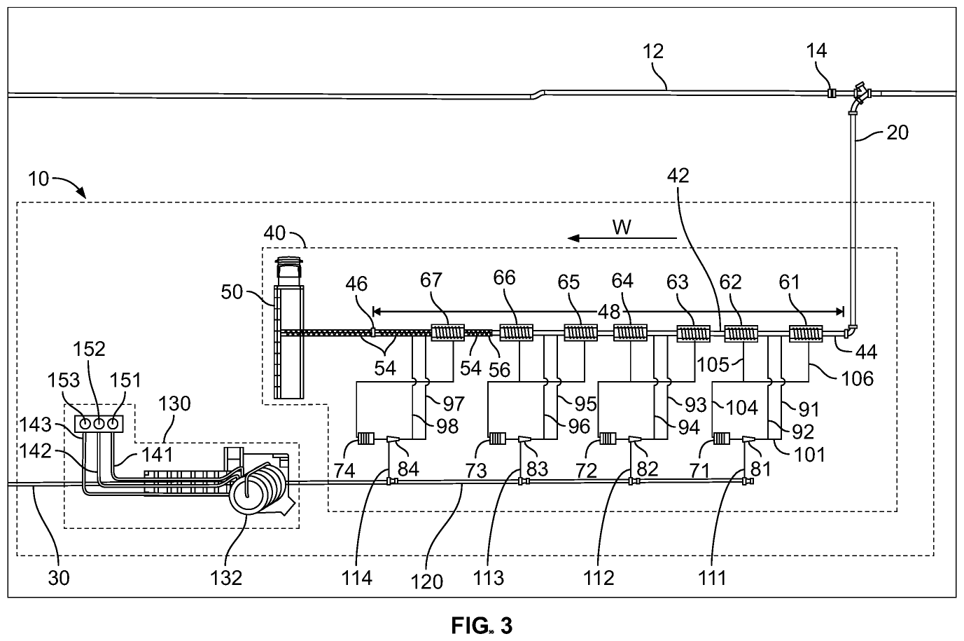

With general reference still to FIGS. 1-2, and more specifically to FIG. 3, the system 10 comprises a sludge recovery module 40 and a water purification module 130. As will be described below, these modules 40, 130 include energy integration features and cooperate to sequentially separate solid, dissolved, liquid and vapor impurities from the unprocessed water to produce a purified water product.

The sludge recovery module 40 converts the water and at least a portion of the dissolved and vapor impurities contained in the unprocessed water to a mixed vapor product (not shown per se), and at least a portion of the solid impurities contained in the unprocessed water to sludge (not shown per se). The sludge is ultimately conveyed to a sludge deposit vessel 50. The sludge may, for example, without limitation, be dried to a water content of less than about 1%, by weight, based on the total weight of the sludge. The sludge comprises mostly solid impurities, but may also include very small or trace amounts of other impurities.

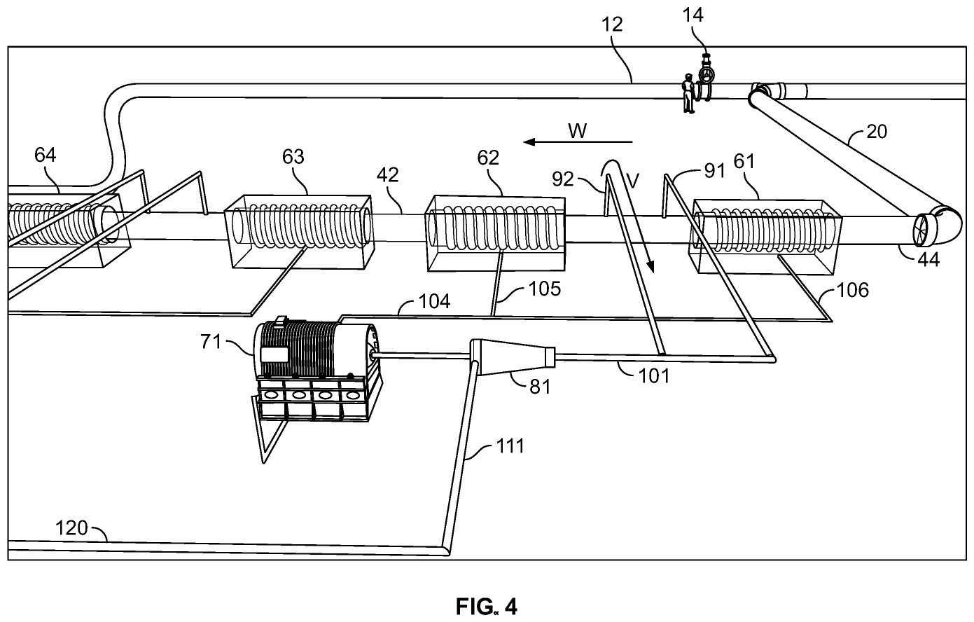

With reference to FIGS. 3-5, the sludge recovery module 40 comprises a heated conduit or pipe 42 having an upstream inlet end 44, a downstream outlet end 46, and a length 48 therebetween. The upstream inlet end 44 of the heated pipe 42 is connected to the inlet pipe 20 (see FIGS. 3 and 4) for receiving unprocessed water which flows along the length 48 of the heated pipe 42. The sludge recovery module 40 also comprises a plurality (i.e., two or more) of induction heaters, such as the seven induction heaters 61, 62, 63, 64, 65, 66, 67 shown in FIG. 3 (and also somewhat visible in FIGS. 1 and 2). The induction heaters 61, 62, 63, 64, 65, 66, 67 are disposed along the length 48 of the heated pipe 42 and are mounted thereto for heating the pipe 42 and the unprocessed water which flows therethrough.

Induction heating involves heating a metal (or any material that conducts electricity) by inducing an electric current through it. For example, induction heating involves providing alternating current to an inductive material, typically in the shape of a coil, which produces a magnetic field in and around the coil. The magnetic field heats the coil, which will then heat another material, such as water, positioned within the coil. Several advantages of heating material, such as water, with an induction process include, but are not limited to, increased efficiency, more precise, constant, and localized heating, improved temperature control, faster heating which consumes less energy than other heating methods, and no flame or combustion is required which eliminates pollution from combustion emissions.

The sludge recovery module 40 further comprises one or more electric power sources, such as the four electric generators 71, 72, 73, 74, for supplying electricity to the induction heaters 61, 62, 63, 64, 65, 66, 67. In the exemplary embodiment of the system 10 shown in FIGS. 1-3, there is a steam turbine 81, 82, 83, 84 associated and in communication with a respective one of the four electric generators 71, 72, 73, 74 to activate each of them to produce electricity. In turn, as can be seen in FIG. 3, each of the four electric generators 71, 72, 73, 74 provides electricity to at least one of the induction heaters 61, 62, 63, 64, 65, 66, 67, whereby the heated pipe 42 and unprocessed water flowing therethrough are heated.

As the unprocessed water flows from the upstream inlet end 44 to the downstream outlet end 46 of the heated pipe 42, water and at least a portion of the dissolved and vapor impurities are heated and thereby converted into a mixed vapor product (not shown per se), while at least a portion of the solid impurities are separated and left behind as sludge in the heated pipe 42. The mixed vapor product generally comprises mostly water (e.g., at least 95% by volume).

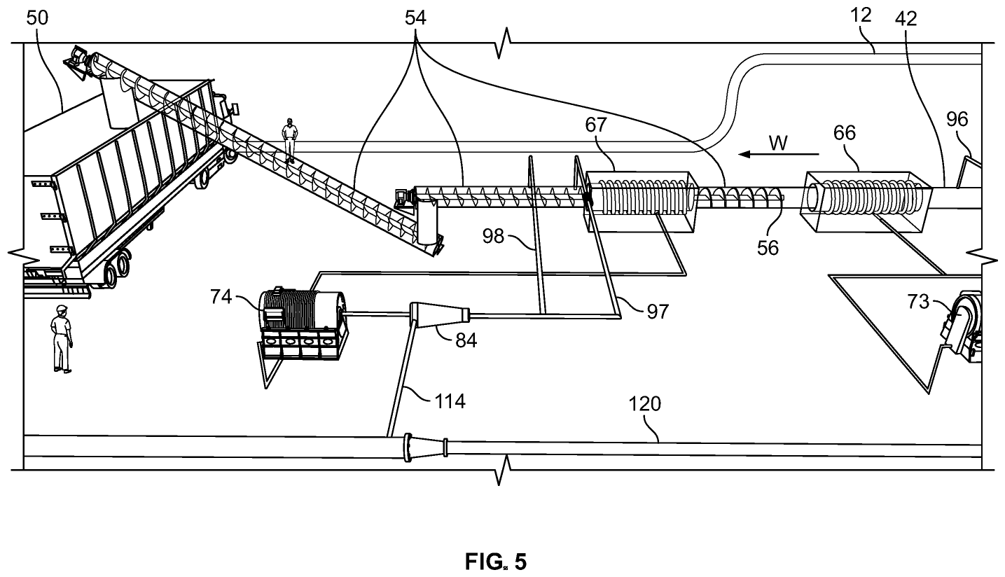

The sludge recovery module 40 also comprises a sludge conveying device, such as the helical screw conveyor 54 shown in FIGS. 3 and 5. As seen most clearly in FIG. 5, the screw conveyor 54 is disposed at least partly within, as well as beyond, the heated pipe 42, extending from a position 56 upstream of the outlet end 46 of the heated pipe 42 to the outlet end 46 and beyond to the sludge deposit vessel 50. With the foregoing arrangement, the screw conveyor 54 moves and conveys sludge from inside the heated pipe 42 to the sludge deposit vessel 50.

The mixed vapor product formed in the heated pipe 42 escapes therefrom through any of a plurality (i.e., two or more) of vapor pipes, such as the eight vapor pipes 91, 92, 93, 94, 95, 96, 97, 98 shown in FIG. 3, which are disposed along the length 48 of the heated pipe 42 and in communication with the heated pipe 42. The mixed vapor product is hot and capable of providing sufficient energy to operate the steam turbines 81, 82, 83, 84 to convert the energy from the hot mixed vapor product to work energy. Accordingly, an energy integrated arrangement is provided in the system 10, whereby hot mixed vapor product is provided, from the heated pipe 42, to each steam turbine 81, 82, 83, 84, directly or indirectly, through at least one vapor pipe 91, 92, 93, 94, 95, 96, 97, 98. In turn, each turbine 81, 82, 83, 84 converts energy from the hot mixed vapor product to work energy which is transferred or otherwise provided to and activates a respective one or more electric generators 71, 72, 873, 74. As described previously, each electric generator 71, 72, 73, 74 produces and provides electricity to at least one of the induction heaters 61, 62, 63, 64, 65, 66, 67. In the foregoing arrangement, the induction heaters 61, 62, 63, 64, 65, 66, 67 heat unprocessed water to produce hot mixed vapor product which, prior to further purification, is recycled to steam turbines 81, 82, 83, 84, which activate electric generators 71, 72, 73, 74 which operate the induction heaters 61, 62, 63, 64, 65, 66, 67, thereby providing an energy integrated process.

In the foregoing arrangement, the sludge recovery module 40 of the system 10 employs induction heaters 61, 62, 63, 64, 65, 66, 67, which are more energy efficient, more precise, and less polluting than other heating processes (e.g., conduction, convection and radiation of heat produced by burning or combustion of fuels) for heating water. Additionally, before subjecting the hot mixed vapor product to further processing to remove impurities and produce purified water, at least a portion of the hot mixed vapor product is cycled or recycled through the sludge recovery module 40 and used to operate steam turbines 81, 82, 83, 84 which, in turn, activate electric generators 71, 72, 73, 74. As described above, the electric generators 71, 72, 73, 74 provide electricity for operating the induction heaters 61, 62, 63, 64, 65, 66, 67 to heat the heated pipe 42, thereby producing more mixed vapor product.

The operation and flow of mixed vapor product and electricity will now be described in detail with reference to FIG. 4 and the two induction heaters 61, 62, the two vapor pipes 91, 92, the electric generator 71, and the steam turbine 81, which are closest to the upstream inlet end 44 of the heated pipe 42. As the induction heaters 61, 62 provide heat to the heated pipe 42 and the unprocessed water flowing in the direction of the arrow W, mixed vapor product is formed and exits the heated pipe 42 via the vapor pipes 91, 92. The mixed vapor product flows through each of the vapor pipes 91, 92, in the direction of the arrow V, through a turbine feed pipe 101 and into the steam turbine 81. The steam turbine 81 provides power to the electric generator 71, which provides electricity, via electric wires 104, 105, 106 to each of the induction heaters 61, 62, which heats more unprocessed water in the heated pipe 42, producing more hot mixed vapor product.

A turbine vapor outlet pipe 111, 112, 113, 114 is provided for each respective steam turbine 81, 82, 83, 84 for conveying mixed vapor product, which remains after energy from the hot mixed vapor product is converted to work energy, from the respective steam turbines 81, 82, 83, 84 to a main vapor pipe 120. The main vapor pipe 120 collects all of the mixed vapor product exiting the respective steam turbines 81, 82, 83, 84 and conveys the combined mixed vapor product to the water purification module 130.

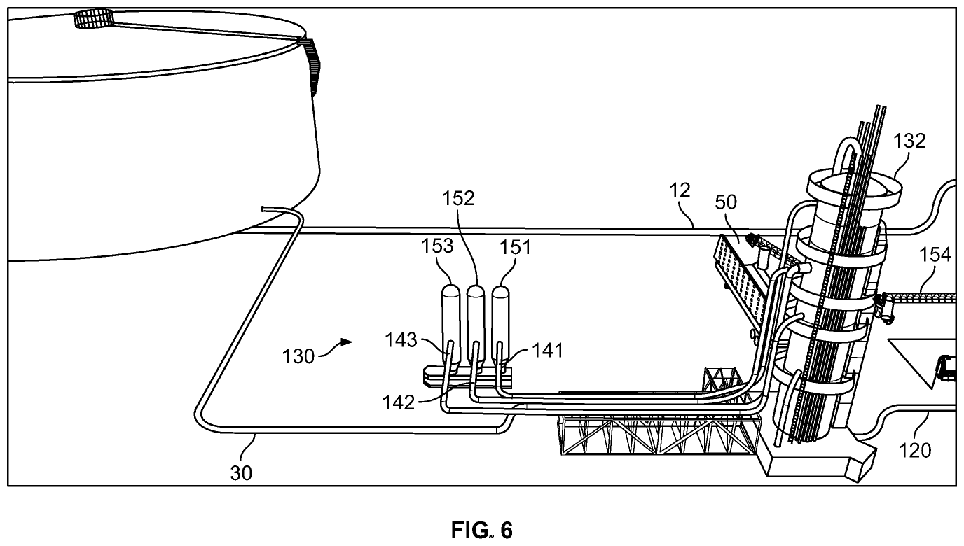

With reference now to FIGS. 3 and 6, the combined mixed vapor product is conveyed to the water purification module 130, via the main vapor pipe 120, from the sludge recovery module 40. The water purification module 130 comprises a distillation column 132 for performing fractional separation and purification of the water and at least a portion of the dissolved and vapor impurities contained in the mixed vapor product. The fractional separation and purification performed in the distillation column 132 produces a purified water product (not shown per se) which is conveyed by the outlet conduit 30 to the storage vessel SV. In many cases, the purified water product leaving the distillation column 132 will still be at least partially in a vapor phase. As mentioned earlier, in such circumstances, it may be advantageous to include one or more condensers (not shown) on the outlet conduit 30 to condense any purified water vapor to purified liquid water before it reaches the storage vessel SV or other destination.

In addition, the fractional separation and purification performed in the distillation column 132 also produces one or more separate concentrated non-aqueous products (not shown). In other words, depending on the particular impurities contained in the unprocessed water provided to the system, and the design and operating conditions of the distillation column 132, at least a portion of the dissolved and vapor impurities may be separated from one another to form the aforesaid one or more concentrated non-aqueous products. As shown in FIGS. 1-3 and 6, each of the one or more concentrated non-aqueous products is conveyed, by a corresponding non-aqueous product conduit 141, 142, 143, to a corresponding non-aqueous product storage vessel 151, 152, 153. It is well within the ability of persons of ordinary skill in the relevant art to design the distillation column 132 according to the particular impurities expected to be present in the unprocessed water and the desired content of the non-aqueous products.

The foregoing description comprises illustrative embodiments of the invention explained and contemplated. Having thus described exemplary embodiments of the present invention, it should be noted by those skilled in the art that the within disclosures are exemplary only, and that various other alternatives, adaptions, variations, and modifications may be made within the scope of the present invention. For instance, listing or numbering the steps of a method or process in a certain order does not constitute any limitation on the order of the steps of that method or process.

Many modifications and other embodiments of the invention will come to mind to one skilled in the art to which this invention pertains having the benefit of the teachings in the foregoing descriptions. Although specific terms may be employed herein, they are used only in a generic and descriptive sense and not for purposes of limitation. Accordingly, the invention described and contemplated herein is not limited to the specific embodiments illustrated hereinabove.

1. A water purification system for recovering purified water from unprocessed water which contains one or more impurities including solid impurities, dissolved impurities, and vapor impurities, the system comprising:
a sludge recovery module which includes:
a heated conduit having a length extending between an upstream inlet end and a downstream outlet end,
a plurality of induction heaters disposed along the length of the heated conduit and mounted in thermal communication therewith and being capable of heating the heated conduit and unprocessed water flowing therethrough, thereby producing sludge product comprising one or more of the solid impurities and hot mixed vapor product comprising water and one or more of the dissolved impurities and the vapor impurities,
one or more electric power sources capable of recovering and converting energy from the hot mixed vapor stream to electricity, and using the electricity to activate the plurality of induction heaters to heat additional unprocessed water, thereby producing additional hot mixed vapor product, and additional sludge product, and
a main vapor conduit, which is in direct or indirect fluid communication with the one or more electric power sources and is capable of receiving and combining mixed vapor product, after energy from the hot vapor stream has been converted to electricity, from the one or more electrical power sources to form a combined mixed vapor product; and
a water purification module which is capable of receiving the combined mixed vapor product from the main vapor conduit of the sludge recovery module, separating at least a portion of the dissolved impurities and vapor impurities from the combined mixed vapor product, and producing purified water.

2. The water purification system of claim 1, wherein each of the one or more electric power sources comprises:
one or more steam turbines, each of which is capable of receiving hot mixed vapor product from the heated conduit and converting energy therefrom to work energy; and
one or more electric generators, each of which is associated with a respective one of the one or more steam turbines and is capable of receiving and converting work energy from the respective one of the one or more steam turbines to electricity, and wherein each of the one or more electric generators is connected to and capable of activating at least one of the plurality of inductive heaters.

3. The water purification system of claim 2, where in the sludge recovery module further includes:
one or more vapor conduits disposed along the length of the heated conduit, wherein each of the one or more vapor conduits is connected, in fluid communication, at an inlet end with the heated conduit and at an outlet end with the respective one of the one or more steam turbines, wherein each of the one or more vapor conduits is capable of receiving hot mixed vapor product from the heated conduit and providing the hot mixed vapor product to the respective one of the one or more steam turbines; and
one or more turbine vapor outlet conduits, each of which is connected, in fluid communication, at an inlet end thereof to the corresponding one of the one or more steam turbines and at an outlet end thereof to the main vapor conduit, wherein each of the one or more turbine vapor outlet conduits is capable of receiving mixed vapor product, after energy from the hot vapor stream has been converted to electricity, from the one or more steam turbines to the main vapor conduit.

4. The water purification system of claim 1, wherein in the water purification module comprises a distillation column.

5. The water purification system of claim 4, wherein the distillation column is capable of fractionally separating dissolved impurities and vapor impurities from the combined mixed vapor product.

6. The water purification system of claim 5, wherein the distillation column is further capable of producing one or more non-aqueous products, each of which comprises a selected dissolved impurity, a selected vapor impurity, of a combination thereof.

7. The water purification system of claim 1, wherein the sludge recovery module further comprises a sludge conveying device disposed proximate the downstream outlet end of the heated conduit and capable of conveying the sludge product out of the downstream outlet end of the heated conduit.

8. The water purification system of claim 7, wherein the sludge recovery module further comprises a sludge deposit vessel which receives and contains the sludge product conveyed thereto by the sludge conveying device.

9. The water purification system of claim 8, wherein sludge product conveyed to the sludge deposit vessel has a water content of less than about 1%, by weight, based on the total weight of the sludge product.

10. The water purification system of claim 1, wherein the purified water is suitable for one or more of: drinking and other household uses, agriculture uses, and industrial processing.

11. A water purification system for recovering purified water from unprocessed water which contains one or more impurities including solid impurities, dissolved impurities, and vapor impurities, the system comprising:
a sludge recovery module comprising
a heated conduit having a length extending between an upstream inlet end and a downstream outlet end,
a plurality of induction heaters disposed along the length of the heated conduit and mounted in thermal communication thereon, wherein each of the plurality of induction heaters is capable of heating the heated conduit and unprocessed water flowing therethrough, thereby producing hot mixed vapor product comprising dissolved impurities and vapor impurities, and sludge product comprising solid impurities,
one or more electric generators, each of which is connected to at least one of the plurality of induction heaters, wherein each of the one or more electric generators is capable of converting work energy to electricity and providing the electricity to one or more of the plurality of induction heaters for heating the heated conduit;
one or more steam turbines, each of which is connected in fluid communication with the heated conduit, wherein each of the one or more steam turbines is capable of receiving hot mixed vapor product from the heated conduit, converting energy from the hot mixed vapor product to work energy, and transferring the work energy to a respective one of the one or more electric generators;
a main vapor conduit capable of receiving and combining mixed vapor product from the one or more turbines, after energy from the hot mixed vapor product has been converted to work energy, and producing a combined mixed vapor product; and
a water purification module capable of receiving the combined mixed vapor product from the main vapor conduit, separating one or more of the dissolved impurities, the vapor impurities, or both, from the combined mixed vapor product, and producing purified water.

12. The water purification system of claim 11, further comprising:
one or more vapor conduits disposed along the length of the heated conduit and each of which is in fluid communication with the heated conduit and with a respective one of the one or more steam turbines, wherein each of the one or more vapor conduits receives hot mixed vapor product from the heated conduit and provides the hot mixed vapor product to the respective one of the one or more steam turbines; and
one or more turbine vapor outlet conduits, each of which is in fluid communication with at least the corresponding one of the one or more steam turbines and the main vapor conduit, wherein after energy from the hot mixed vapor product has been converted to work energy, each of the one or more turbine vapor outlet conduits receives mixed vapor product from the corresponding one of the one or more turbines, and provides the mixed vapor product to the main vapor conduit.

13. The energy integrated water purification system of claim 11, wherein in the water purification module comprises a distillation column.

14. The energy integrated water purification system of claim 13, wherein the distillation column is capable of fractionally separating dissolved impurities and vapor impurities from the combined mixed vapor product.

15. The energy integrated water purification system of claim 14, wherein the distillation column is further capable of producing one or more non-aqueous products, each of which comprises a selected dissolved impurity, a selected vapor impurity, or a combination thereof.

16. The energy integrated water purification system of claim 11, wherein the sludge recovery module further comprises a sludge conveying device disposed proximate the downstream outlet end of the heated conduit and capable of conveying the sludge product out of the downstream outlet end of the heated conduit.

17. The energy integrated water purification system of claim 16, wherein the sludge recovery module further comprises a sludge deposit vessel which receives and contains the sludge product conveyed thereto by the sludge conveying device.

18. A method for recovering purified water from unprocessed water containing one or more impurities including solid impurities, dissolved impurities, and vapor impurities, the method comprising the steps of:
separating solid impurities from the unprocessed water by heating the unprocessed water using a plurality of inductive heaters and producing sludge product containing solid impurities, and hot mixed vapor product containing water and one or more of dissolved impurities, vapor impurities, or a combination thereof,
converting energy from the hot mixed vapor product to electricity, at least partially operating the plurality of inductive heaters using the electricity to heat additional unprocessed water and thereby produce additional sludge product and additional hot mixed water vapor product, and collecting and combining mixed vapor product, which remains after converting energy from the hot mixed vapor product, to form a combined mixed vapor product; and
separating one or more of dissolved impurities, vapor impurities, or combinations thereof, from the combined mixed vapor product and producing purified water.

19. The method of claim 19, wherein the step of converting energy from the hot mixed vapor product to electricity is performed at least in part by:
providing hot mixed vapor product to one or more turbines, each of which produces work energy and the mixed vapor product which remains after converting energy from the hot mixed vapor product, and
transferring the work energy to one or more electric generators, each of which converts work energy to electricity, which is used to operate, at least in part, the plurality of inductive heaters.

20. The method of claim 19, wherein the step of separating one or more of dissolved impurities, vapor impurities, or combinations thereof, from the combined mixed vapor product comprises fractional separation and one or more non-aqueous products are also produced, each of the one or more non-aqueous products comprising a selected dissolved impurity, a selected vapor impurity, or a combination thereof.
